(19) United States
(12) Patent Application Publication
(10) Pub. No.: US 2026/0160954 A1
(43) Pub. Date: Jun. 11, 2026

(54) HIGH-DENSITY OPTICAL CONNECTOR AND OPTICAL MODULE INCLUDING THE SAME

(71) Applicant: Senko Advanced Components, Inc., Hudson, MA (US)

(72) Inventor: Kazuyoshi TAKANO, Tokyo (JP)

(73) Assignee: Senko Advanced Components, Inc., Hudson, MA (US)

(21) Appl. No.: 19/414,199

(22) Filed: Dec. 9, 2025

Related U.S. Application Data
(60) Provisional application No. 63/729,901, filed on Dec. 9, 2024.
(60) Provisional application No. 63/729,896, filed on Dec. 9, 2024.
(60) Provisional application No. 63/775,033, filed on Mar. 20, 2025.

(51) Int. Cl. G02B 6/38; G02B 6/26; G02B 6/32; G02B 6/36

(52) U.S. Cl. CPC G02B 6/3809; G02B 6/262; G02B 6/32; G02B 6/3616; G02B 6/3644; G02B 6/3672

(57) ABSTRACT

A high-density optical connector for demountable coupling to an external component is provided. The optical connector includes a fiber block including a front surface, a back surface and passages extending from the back surface towards the front surface. Each passage is configured to receive an optical fiber. A carrier is attached to the front surface of the fiber block, including a plurality of elastic averaging features spaced apart from each other. The carrier includes a plurality of first lenslets arranged in a first planar array. The elastic averaging features are arranged in a second planar array interspersed among the first lenslets.

### CROSS-REFERENCE TO RELATED APPLICATION

The present invention claims priority to U.S. Provisional Patent Application No. 63/729,896 filed on Dec. 9, 2024; U.S. Provisional Patent Application No. 63/729,901 filed on Dec. 9, 2024, and U.S. Provisional Patent Application No. 63/775,033 filed on Mar. 20, 2025, the inventions of which are incorporated hereby by references in their entireties.

### FIELD OF THE INVENTION

The present invention generally relates to a high-density optical connector configured to provide precise alignment during coupling with another high-density optical connector or an optoelectronic device.

### BACKGROUND

Optical fiber connectors are used to connect optical fibers in a variety of applications including: the telecommunications network, local area networks, data center links, and for internal links in high performance computers. As the complexity of transmission networks increases and the appliances that are used are increasingly miniaturized, the density of the optical connections is becoming ever more important. The achievable densities are essentially governed and limited by comparatively large connector housing. Some optical fiber connectors of the MT type, like SN-MT connectors provided by the present applicant can achieve a higher density by using a common ferrule for a plurality of fibers in the form of ribbons. However, the connector housing makes it challenging to further increase the density in certain circumstances, e.g., used as I/O for applications of silicon photonics integrated circuits (“PIC”).

The existing technology utilizes a fiber array unit (“FAU”) for inputting and receiving light from a PIC. Many applications in telecommunications, for example, are expected to require optical fiber arrays including more than one hundred (perhaps more than one thousand) optical fibers. Unfortunately, single-plane arrays are impractical for such applications. Additionally, mutual alignment between the FAU and PIC becomes difficult as the number of the fibers increases.

Conventional alignment techniques often employ active alignment processes, which involve real-time optical feedback to optimize coupling efficiency. While effective, active alignment is costly, time-consuming, and unsuitable for high-volume manufacturing.

Passive alignment methods have emerged as an alternative, leveraging mechanical features such as alignment pins, V-grooves, and precision housings to position fibers relative to PIC facets without active feedback. However, passive alignment introduces significant challenges. Optical coupling between PIC waveguides and standard single-mode fibers requires submicron positional accuracy due to the small mode field diameter of integrated waveguides. Variations in fabrication tolerances, thermal expansion mismatches between dissimilar materials, and assembly-induced angular offsets can lead to substantial insertion loss. Furthermore, demountable configurations—where connectors are repeatedly mated and unmated—compound these issues by introducing wear and reducing positional repeatability over time. Multi-channel fiber arrays exacerbate alignment complexity, as cumulative errors across multiple fibers can degrade overall system performance.

These limitations underscore the need for improved passive alignment solutions that maintain high coupling efficiency, enable repeatable demountable connections, and support scalable manufacturing for high density demands.

### SUMMARY

The present invention provides a demountable optical coupling/module between a connector and a receptacle (e.g., on or part of a PIC or another connector) is configured with interspersed passive alignment and optical alignment features in a high-density package. In one embodiment, the optical elements are distributed in a first planar array, and the passive alignment features are distributed in a second planar array, and wherein the optical elements are interspersed with the passive alignment features.

An aspect of the present invention is directed to a high-density optical connector comprising a fiber block including a front surface, a back surface and passages extending from the back surface towards the front surface, each passage being configured to receive an optical fiber; and a carrier attached to the front surface of the fiber block and including a plurality of elastic averaging features spaced apart from each other, wherein the carrier includes a plurality of first lenslets interspersed with plurality of the elastic averaging features.

In some embodiments, the plurality of first lenslets are distributed in a first planar array, and the plurality of the elastic averaging features are distributed in a second planar array.

In some embodiments, each elastic averaging feature is provided with a second lenslet, and each of the first lenslet and second lenslet is in optical alignment with an optical fiber received in each passage.

In some embodiments, the elastic averaging features are integrally formed with the carrier.

In some embodiments, the first lenslets are integrally formed with the carrier.

In some embodiments, the carrier is integrally formed with the fiber block as a single unitary structure.

In some embodiments, the passages may include a first group of passages and a second group of passages, and the first lenslet is configured to align with a passage of the first group and the second lenslet is configured to align with a passage of the second group.

In some embodiments, the carrier may include a pair of raised pads on either pair of two opposite edges.

In some embodiments, the carrier is adhered to the fiber block by an adhesive.

In some embodiments, wherein the fiber block is configured to support a 2-D array of optical fibers.

In some embodiments, the fiber block is formed from multiple layers stacked on top of each other, with each layer defining complementary grooves, such that adjacent layers cooperate to form the passage configured to securely hold an optical fiber.

In some embodiments, the first lenslet and second lenslet have different focal lengths.

In some embodiments, the elastic averaging features are configured as protrusions, and the second lenslets are located at the top of the corresponding protrusions.

In some embodiments, the fiber block is formed from multiple layers stacked on top of one another, each layer defining complementary grooves such that adjacent layers cooperate to form the passage.

Another aspect of the present invention is directed to an optical module comprising a high-density optical connector of claim 1; and a mating carrier having a plurality of elastic averaging features configured to demountably mate with the high-density optical connector and a plurality of first lenslets alternately arranged with the elastic averaging features.

In some embodiments, each elastic averaging feature has a second lenslet.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary and are intended to provide an overview or framework to understand the nature and character of the claims.

### BRIEF DESCRIPTION OF THE DRAWINGS

The present invention will become more fully understood from the detailed description given hereinbelow and the accompanying drawings, which are given by illustration only, and thus are not limited to the present invention, and wherein:

FIG. 1A schematically illustrates a perspective view of high-density optical connectors in accordance with an embodiment of the present invention in a mated state, FIG. 1B schematically illustrates a perspective view of the high-density optical connectors of FIG. 1A in unmated state, and FIG. 1C schematically illustrates an enlarged partial view of the high-density optical connectors of FIG. 1B,

FIG. 2A is a cross-section view of the high-density optical connectors of FIG. 1A in the mated state, and FIG. 2B is an enlarged view of portion A of FIG. 2A,

FIG. 3A schematically illustrates the light beam between the high-density optical connectors of FIG. 1A, and FIG. 3B schematically illustrates the light path between the high-density optical connectors of FIG. 1A,

FIG. 4A schematically illustrates a perspective view of high-density optical connectors in accordance with another embodiment of the present invention, and FIG. 4B schematically illustrates an exploded view of high-density optical connectors of FIG. 4A,

FIG. 5A is a cross-section view of the high-density optical connectors of FIG. 4A in mated state, and FIG. 5B is an enlarged view of portion B of FIG. 5A,

FIGS. 6A to 6D schematically illustrates the demountable coupling of the high-density optical connector 100 and a carrier on a PIC, and FIG. 6E schematically illustrates several high-density optical connectors 100 are demountably coupled onto PCB,

FIG. 7A schematically illustrates in mated state, FIG. 7B schematically illustrates high-density optical connectors of 7A in unmated state, FIG. 7C is a cross-section view of the high-density optical connectors of FIG. 7B, and FIG. 7D is an enlarged view of portion C of FIG. 7C, and

FIG. 8A schematically illustrates high-density optical connectors in accordance with yet the other embodiment of the present invention, FIG. 8B schematically illustrates an exploded view of the high-density optical connectors of FIG. 8A, and FIG. 8C is a cross-section view of the high-density optical connectors of FIG. 8A in mated state, and FIG. 8D is an enlarged view of portion D of FIG. 8C.

### DETAILED DESCRIPTION

This invention is described below in reference to various embodiments with reference to the figures, and is not limited to any particular system, device and method described, as these may vary. The terminology used in the description is for the purpose of describing the versions or embodiments only and is not intended to limit the scope. In the drawings, same or similar reference numerals are used for same or similar elements throughout. With reference to the drawings, “front” refers to the side of the component facing the mating direction, and “back” refers to the opposite of the mating direction. “Top” denotes the surface opposite the bottom, which faces away from the substrate in the normal operating position. “Bottom” refers to the surface oriented toward the substrate or mounting plane. “Side” refers to the lateral surfaces extending between the front and back. “Inner” refers to surfaces or portions closer to the central axis or interior of the component, while “outer” refers to surfaces or portions farther from the central axis or toward the exterior. These terms are used for clarity in describing relative positions and do not limit the disclosure to any particular orientation unless expressly stated.

As described herein, the high-density optical connector can be removably attached, via a “separable” or “demountable” or “detachable” action that accurately optically aligns the optical fibers to optical fibers or the optical ports communicating optical signals with optoelectronic device along a desired optical path. To maintain optical alignment for each connect and disconnect and reconnect, this connector needs to be precisely and accurately aligned passively to the receptacle. In accordance with the present invention, the precise alignment is achieved using a passive mechanical alignment, specifically, elastic averaging alignment, constructed from geometric features on two facing contact surfaces/bodies. Further, “alignment” may refer to any alignment, such as structural and/or optical alignment. For example, when the components are in optical alignment means an optical axis of a first component is orientated relative to an optical axis of a second component such that the light signal passes therebetween with a minimal loss or distortion. With the foregoing as introduction, the present invention may be summarized below.

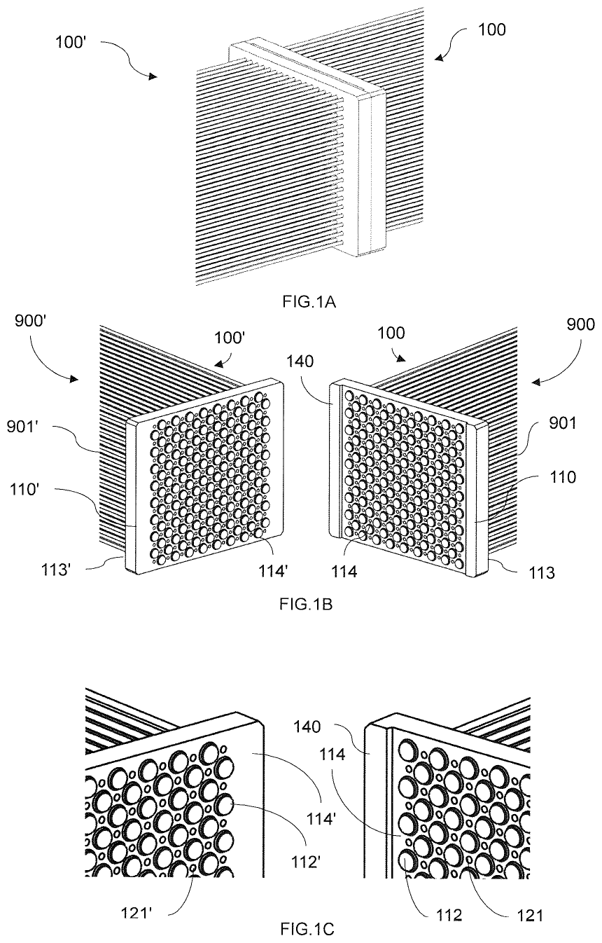

FIGS. 1A and 1B schematically illustrates high-density optical connectors 100 and 100′ in accordance with an embodiment of the present invention in a mated state and unmated state, respectively. The optical connector 100, 100′ includes a fiber block 110, 110′ supporting a fiber group 900, 900′ including a 2-D array of optical fibers. The fiber block and the optical fibers held are collectively referred to as fiber array. It will be apparent to one of ordinary skill in the art that the fibers may be grouped in various sizes and configured in a M×N arrangement. In this example, the fiber group 900, 900′ is configured in a 17×17 arrangement of optical fibers 901, 901′, whereas in other examples, the fiber group may have different arrangements and different numbers of optical fibers, such as 15×15 or 19×19 , with more or less fibers depending on the design requirements, while remaining within the scope of this disclosure.

The optical connectors 100 and 100′ have the same or similar structures; therefore, a detailed description of optical connector 100′ is omitted for clarity and brevity. Unless otherwise specified, the following description of optical connector 100 applies equally to optical connector 100′.

The fiber block 110 includes a front surface 114 and a back surface 113. As shown in FIG. 1C, the front surface 114 is provided with a plurality of elastic averaging features 112 that protrude from the front surface 114 and spaced apart from each other. Thus, the front surface of the fiber block serves as the coupling surface to the external component, e.g., another high-density optical connector or an optoelectronic device, e.g., PIC. In this example, the elastic averaging features 112 are configured in the manner of bumps 112 and integrally formed with the fiber block 110.

The pluralities of the bumps 112 and 112′ on the front surfaces of the fiber blocks 110 and 110′ are arranged in complementary arrays such that, when the optical connectors 100 and 100′ are mated, each bump 112, 112′ is in point contact with four surrounding bumps 112′, 112, except for the bumps at or near the edges. For example, each bump 112 makes four-point contact with the surrounding four bumps 112′, receiving opposing forces from these contact points which collectively act to restrain the bump 112 in a predetermined position. In this manner, the bump 112 is restrained by the surrounding bumps 112′ of the mating optical connector 100′ through physical contact, thereby enabling a demountable coupling that allows for repeated decoupling and recoupling with high repeatability and positional accuracy. As a result, misalignment is minimized and overall structural integrity is enhanced. Further reference is made to US Patent Publications Nos. US20240085633A1 and US20240142722A1 for detail discussions of these elastic averaging features/bumps, which are also incorporated hereby by references in entirety. Elastic averaging features having other geometries may be adopted for coupling the front surfaces 114 and 114′ to achieve the desired demountable coupling based on elastic averaging principles.

As shown in FIG. 1B, the fiber block 110 is provided with raised pads 140 along two opposite edges on the same side as the elastic averaging features. The raised pads may be provided on either pair of two opposite edges of the fiber block. The raised pad 140 has a certain height from the front surface 114 to provide some level of barrier to debris from contaminating the front surfaces 114 and 114′. The height of the raised pads 140 above the front surface 114 is chosen to prevent the elastic averaging features of front surface 114 touching the opposing front surface 114′ and the elastic averaging features of the front surface 114′ touching the front surface 114 when the optical connectors 100 and 100′ are mated, so as to avoid over-constraining in the direction normal to the front surfaces 114 and 114′, which would otherwise not conform to elastic averaging coupling. For example, the height of the raised pad 140 may be the same or less than the height of the elastic averaging features 112, i.e., shorter than the opposing elastic averaging features 112′. In this example, the raised pad 140 is provided solely on the fiber block 110. However, it may additionally be provided onto the fiber block 110′ too as long as the combined height of the raised pads on both fiber blocks 110 and 110′ do not exceed the height of the elastic averaging feature. For this elastic averaging coupling, constraints are established by a plurality of point contacts between the complementary arrays of elastic averaging features.

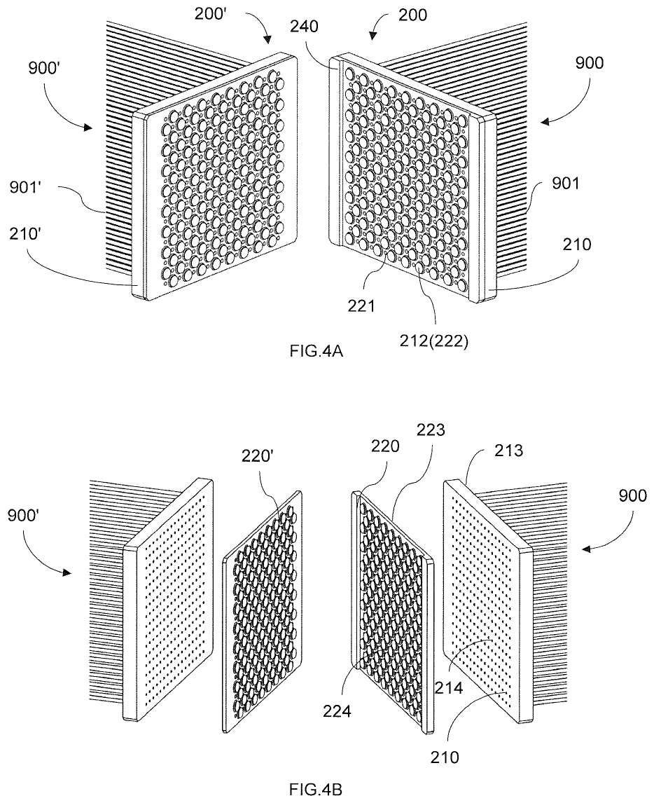

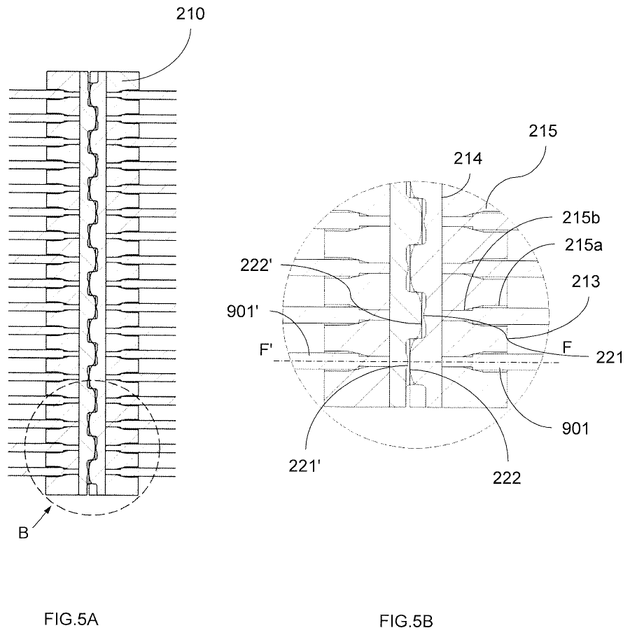

FIG. 1C shows an enlarged partial view of the high-density optical connectors 100, 100′ of FIG. 1B. In this embodiment, the elastic averaging feature is in the form of bump, however, other forms of elastic averaging feature will still fall within the scope of this invention. For connector 100, the front surface 114 of the fiber block 110 is provided with a plurality of first lenslets 121 positioned within the spacing between the discrete distributed bumps 112. That is, the first lenslets 121 and the bumps 112 are alternately arranged (i.e., interspersed) on the front surface 114 at a predetermined distance. In other words, the first lenslets may be distributed in a first planar array, while the bumps may be distributed in a second planar array. Each first lenslet 121 is configured to be in optical alignment with an optical fiber 901, which will be explained in detail hereinunder. Thus, the first lenslet 121 functions to focus the incident light onto the core region of the optical fiber 901. In this example, the first lenlets 121 are integrally formed with the fiber block 110, whereas in other examples, the first lenslets may be formed as a separate layer and then adhered to the front surface of the fiber block (see embodiment of FIGS. 4A to 5B). The configuration of the fiber block 110′ is similar to that of the fiber block 110, but with the complementary surface features staggered with respect to the facing surface features on the fiber block 110.

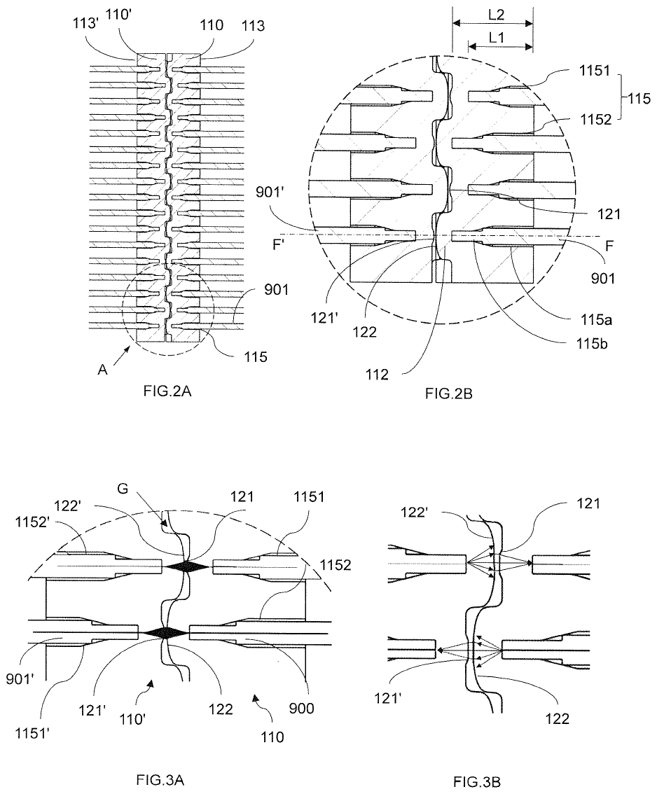

Reference now made to FIGS. 2A and 2B, the back surface 113 of the fiber block 110 is provided with multiple passages 115 each configured to extend from the back surface 113 a certain distance toward the front surface 114 and receive an optical fiber 901. The multiple passages 115 are divided into a first group of passages and a second group of passages. Each passage 1151 of the first group has a first length L1 and is designed to correspond to each first lenslet 121, while each passage 1152 of the second group has a second length L2 and is designed to correspond to each bump 112. In this example, the lengths L1 and L2 are different and L2 is larger than L1, while in some examples, they can be the same. The passages 1151 of the first group and passages 1152 of the second group are collectively referred to as passages 115 in this context.

Each passage 115 is formed as a blind passage having a first section 115a adjacent to the back surface 113 and a second section 115b connected to the first section 115a. The second section 115b is narrower than the first section, i.e., smaller in a radical direction and is dimensioned to receive a bare end section of the optical fiber 901 (i.e., stripping the outer jacket and protective Kevlar).

Each bump 112 of the fiber block 110 includes a second lenslet 122 at its top surface, for example the convex shape. The second lenslet 122 of the fiber block 110 is configured to be in optical alignment with each optical fiber 901 received in the passage 1152 of the second group for shaping light to/from the optical fibers. The fiber block 110′ has similar array of passages 115′ (including passages 1151′ of first group and passages 1152′ of second group) and lenslets 121′ and 122′, staggered with respect to the opposing fiber block 110. As shown in FIGS. 2A and 2B, the bumps on one fiber block each extends into the complementary spacing among bumps on the other fiber block. The optical fibers 901, second lenslet 122, first lenslet 121′ and optical fiber 901′ are configured to be in optical alignment to transmit the optical signal between I/O ports of the optical fibers 901 and 901′. The second lenslet 122 serves to collimate (e.g., expand) the beam of light from the optical fiber 901 to be less dependent on stringent optical alignment so as to reduce optical loss. The collimated light beam then passes through first lenslet 121′ and then focuses onto the core region of the optical fiber 901′. Likewise, the second lenslet 122′ is configured to transform the divergent light from the optical fiber 901′ into a substantially collimated beam, and the first lenslet 121 is configured to focus the collimated beam onto the core region of the optical fiber 901. The optical fibers 901 and 901′ are positioned that the axis F of the optical fiber 901 are in alignment with the axis F′ of the optical fiber 901′. The first lenslet and second lenslet may have different focal lengths.

The material of the fiber block may be selected from a group of glass, silicon or polymer that is optically transparent to the working wavelength of the intended optical signals between the optical fibers 901 and 901′. In the present invention, the first lenslet and second lenslet have different sizes.

FIGS. 3A and 3B schematically illustrate the light beams and light paths between the high-density optical connectors 100, 100′ of FIG. 1A. The optical axes of lenslet 122 and opposing lenslet 121′ are aligned, and the optical axes of the lenslet 122′ and opposing lenslet 121 are aligned. The incident light emitted from the optical fiber 901 is collimated by the second lenslet 122 and subsequently focused by the first lenslet 121′ towards the optical fiber 901′. Similarly, the incident light emitted from the optical fiber 901′ is collimated by the second lenslet 122′ and subsequently focused by the first lenslet 121 towards the optical fiber 901. An air gap G is formed between the optical connectors 100 and 100′ as a result of the configuration and shape of the first and second lenslets. The air gap provides a separation that prevents direct physical contact between the opposing optical surfaces, thereby reducing the risk of mechanical damage and contamination. In certain embodiments, an index-matching material may be disposed within the air gap to minimize Fresnel reflections and reduce optical loss at the interface. The index-matching material may comprise a gel, liquid, or other suitable substance having a refractive index substantially similar to that of the optical fibers or lenslets, thereby improving optical coupling efficiency between the optical connectors.

In this embodiment, the first lenslets 121 and second lenslets 122 are integrated into the fiber block 100. In another embodiment, the first lenslets and second lenslets are formed separately from the fiber block, for example, they are integrated into a carrier rather than the fiber block, and then adhered to the fiber block. That is, the lens array and the fiber array are formed as separate components rather than being integrally constructed as a one-piece unit. This configuration allows for independent manufacturing and alignment of the lens/microlens array and fiber array, thereby improving assembly flexibility and reducing production complexity. By separating the lens array from the fiber array, variations in optical performance can be minimized through precise positioning and calibration during assembly. In some embodiments, the lens array may be fabricated from a material optimized for optical transmission, while the fiber array may be formed from a material selected for mechanical stability. Alternative embodiments may include the use of adhesive bonding, mechanical fastening, or thermal fusion techniques to secure the lens array to the fiber array while maintaining positional accuracy. Such a modular design facilitates easier replacement or customization of individual components without requiring redesigning the entire optical connector assembly.

In FIGS. 4A and 4B, a high-density optical connector 200, 200′ has a similar structure to optical connector 100, 100′ of the previous embodiment. The optical connectors 200 and 200′ have the same or similar structures; therefore, a detailed description of optical connector 200′ is omitted for clarity and brevity. Unless otherwise noted, the following description of optical connector 200 applies equally to optical connector 200′.

The optical connector 200 includes a fiber block 210 supporting the fiber group 900 and a carrier 220 connected to the fiber block 210. The fiber block 210 includes a front surface 214, a back surface 213 and passages 215 therebetween. The carrier 220 is adhered to the front surface 214 of the fiber block 210 through an adhesive such as epoxy. One of ordinary skill in the art would understand that other means can be used to connect the fiber block and the carrier, e.g., welding, bonding, etc., based on the materials of the fiber block and the carrier.

In this embodiment, the first lenslets 221 and the elastic averaging features 212, i.e., the second lenslets 222 are integrally formed with the carrier 220 in the same arrangement as the previous embodiment of FIGS. 1A to 1C. In detail, the carrier 220 includes a front surface 224 provided with the first lenslets 221 and the elastic averaging features 212, and a back surface 223 configured to be adhered to the front surface 214 of the fiber block 210. The front surface 224 of the carrier 220 serves as the coupling surface to the external component, e.g., another high-density optical connector or an optoelectronic device, e.g., PIC. The carrier 220 is made of the material selected from silicon, glass, or polymer that is optically transparent to the working wavelength of the intended optical signals between the optical connectors 200 and 200′. The elastic averaging features are manufactured or etched to the carrier and are arranged in complementary arrays on the front surfaces of the carriers 220 and 220′. Similar to the previous embodiment, the elastic averaging feature is in the form of bump and thus its detail description will be omitted for clarity and brevity.

The front surface 224 of the carrier 220 is provided with a pair of raised pads 240. The raised pad 240 is similar to the raised pad 140 of the previous embodiment, thus its detailed explanation will be omitted for clarity and brevity. The carrier 220′ is lack of the raised pad. The raised pad may be provided on one of the carriers of the two optical connectors, or on both carriers, as long as the combined height of the raised pads is sufficient to prevent the elastic averaging feature from contacting the front surface of the carrier of the opposing optical connector.

Now referring to FIGS. 5A and 5B, the fiber block 210 is provided with the passage 215 extending from the back surface 213 to the front surface 214. Unlike the previous embodiment, the passage 215 includes a through hole having a first section 215a adjacent to the back surface 213 and a second section 215b connected to the first section 215a. The second section 215b is narrower than the first section 215a, i.e., smaller in a radical direction and is dimensioned to receive a bare end section of the optical fiber 901 (i.e., stripping the outer jacket and protective Kevlar). The fiber block may be formed from multiple layers stacked on top of each other, with each layer defining complementary grooves, such as V-grooves or C-grooves, such that adjacent layers cooperate to form the passage configured to securely hold an optical fiber therein.

Similar to the previous embodiment, the optical fibers 901, second lenslet 222, first lenslet 221′, and optical fiber 901′ are configured to be in optical alignment to transmit the optical signal between I/O ports of the optical fibers 901 and 901′. In particular, the second lenslet 222 is configured to transform the divergent light from the optical fiber 901 into a substantially collimated beam, and the first lenslet 221′ is configured to focus the collimated beam onto the core region of the optical fiber 901′; the second lenslet 222′ is configured to transform the divergent light from the optical fiber 901′ into a substantially collimated beam, and the first lenslet 221 is configured to focus the collimated beam onto the core region of the optical fiber 901. The optical fibers 901 and 901′ are positioned that the axis F of the optical fiber 901 are in alignment with the axis F′ of the optical fiber 901′.

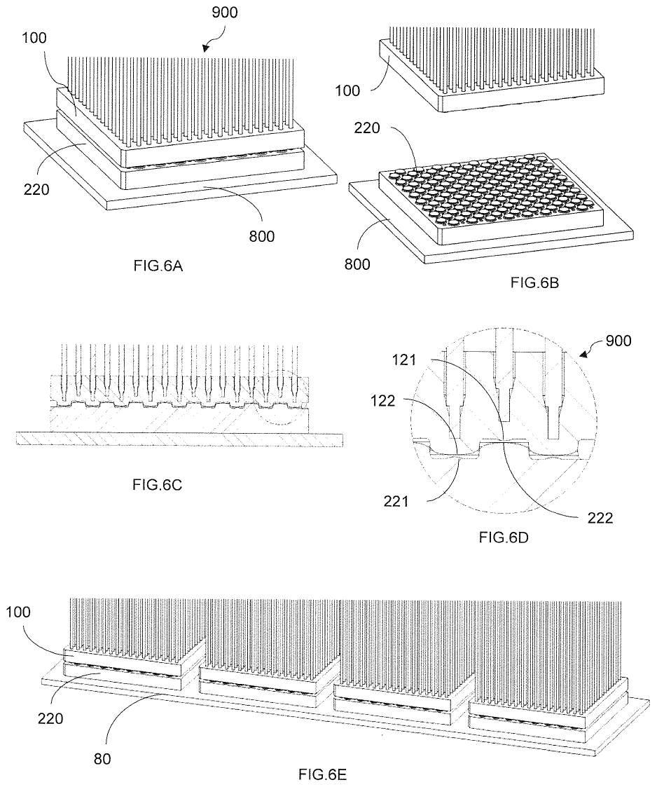

The high-density optical connector in accordance with present invention may also be coupled with an external component, e.g., PIC, rather than another high-density optical connector of the same kind. Referring to FIGS. 6A to 6D, the optical connector 100 is demountably coupled with the carrier 220 mounted on a PIC 800. The carrier 220 as described above is attached to the PIC 800 through any conventional means, for example permanently attached to the PIC by an adhesive. The elastic averaging features on the fiber block 110 and carrier 220 include complementary arrays such that the optical connector 100 is detachably mated to the carrier 220. In this example, as shown in FIG. 6D which is an enlarged view of the portion of FIG. 6C, the carrier 220 is positioned that the first lenslets 221 is in optical alignment with the second lenslet 122 of the optical connector 100, and second lenslets 222 is in optical alignment with the first lenslet 121 of the optical connector 100 such that the I/O ports of the external component PIC 800 and the I/O ports of the fiber group 900 of the optical connector 100 are optically aligned. As described above, the carrier 220 may be made of optically transparent material, allowing the light beam to be transmitted from and received by the I/O ports of the PIC 800.

FIG. 6E schematically illustrates multiple high-density optical connectors 100 are demountably coupled with the carriers 220 on PCB 80. One of ordinary skills in the art would understand that the optical connector 200 could be used interchangeably as it exhibits the same optical characteristics as the optical connector 100.

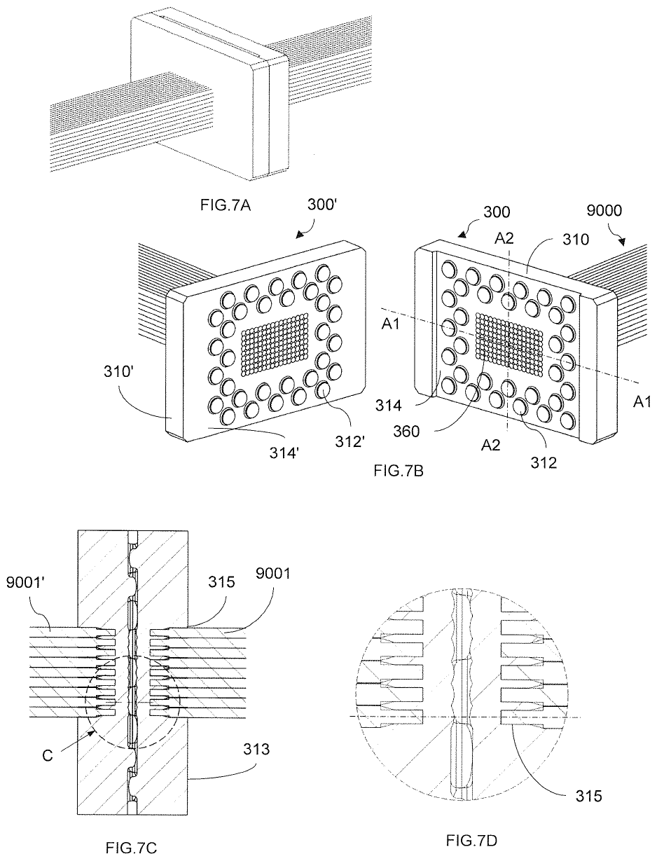

FIGS. 7A to 7D illustrate high-density optical connectors 300, 300′ in accordance with yet another embodiment of the present invention. The optical connectors 300 and 300′ have the same or similar structures; therefore, a detailed description of optical connector 300′ is omitted for clarity and brevity. Unless otherwise noted, the following description of optical connector 300 applies equally to optical connector 300′.

In this embodiment, the optical connector 300 includes a fiber block 310 supporting a fiber group 9000. Elastic averaging features 312 are essentially integrated into the fiber block 310 of the optical connector 300. Unlike the previous embodiments, the fiber block 310 is provided with a 2-D microlens array 360 at its central region with respect to axes A1 and A2. As shown in FIG. 7B, the microlens array 360 is surrounded by the elastic averaging features 312, i.e., bumps 312. The microlens array 360 is configured to be integrated into the fiber block 310 and positioned with respect to the fiber group 9000. In detail, each microlens of the microlens array 360 is optically aligned with a fiber 9001 of the fiber group 9000. Each fiber 9001 is received within each passage 315 which extends from the back surface 313 of the fiber block 310 a certain distance towards the microlens array 360. The passage 315 includes a narrowed section to receive a bare end section of the optical fiber 9001 (i.e., stripping the outer jacket and protective Kevlar).

Similarly, the fiber group 900 includes 2-D array of optical fibers and is configured in M×N arrangement. In this example, the fiber group 9000 has a 9×16 arrangement of 144 optical fibers 9001, whereas in other examples, the fiber group may have different arrangements and different numbers of optical fibers. The microlens array 360 serves to transmit optical signals from and to the I/O ports of the fiber group 9000. The material of the fiber block may be selected from a group of glass, silicon or polymer that is optically transparent to the working wavelength of the intended optical signals between the optical fibers 9001 and 9001′.

The fiber block 310 is provided with the raised pads 340 along two opposite edges on the same side as the elastic averaging features. The raised pads may be provided on either pair of two opposite edges of the fiber block. The raised pad 340 has a certain height from the front surface 314 to provide some level of barrier to debris from contaminating the front surfaces of the fiber blocks 310 and 310′. The height of the raised pads 340 above the front surface 314 is chosen to prevent the elastic averaging features of front surface 314 touching the opposing front surface 314′ and the elastic averaging features of front surface 314′ touching the front surface 314 when the optical connectors 300 and 300′ are mated, to avoid over-constraining in the direction normal to the front surfaces 314 and 314′, which would otherwise not conform to elastic averaging coupling. For example, the height of the raised pad 340 may be the same height or less than the height of the elastic averaging features/bumps 312, i.e., shorter than the opposing elastic averaging features/bumps 312′. In this example, the raised pad 340 is provided solely on the fiber block 310. However, it may additionally be provided onto the fiber block 310′ too as long as the combined heights of the raised pads onto fiber blocks 310′ as long as the combined height of the raised pads on both fiber blocks 310 and 310′ do not exceed the height of the elastic averaging feature. For this elastic averaging coupling, constraints are established by a plurality of point contacts between the complementary arrays of elastic averaging features.

The fiber blocks 310 and 310′ includes complementary arrays of elastic averaging features that the optical connectors 300 and 300′ are demountably coupled with each other. The elastic averaging features are disposed circumferentially about the central region comprising microlens array 360, and are configured to be symmetric with respect to the axes A1 and A2 to ensure a uniform contact between the optical connectors 300 and 300′, thereby reducing optical loss during the coupling of the optical connectors 300 and 300′. For illustration purposes only, in FIG. 7B, two rows of elastic averaging features are shown around each side of the central region. However, any number of elastic averaging features may be arranged in accordance with the design requirements without departing from the scope and spirit of the present invention.

When the optical connectors 300 and 300′ are coupled together, the fiber block 310 and 310′ are in point contact and interlocked through mating the elastic averaging features 312 and 312′ of the optical connectors 300 and 300′. As shown in FIG. 7D, the optical axis of the microlenses in microlens array 360 are aligned with that of the microlenses in the microlens array 360′, and in turn the optical signal is transmitted between the I/O ports of fiber group 9000 and 9000′ with minimized optical loss.

In an alternate embodiment, the microlens array and the fiber array are formed as separate components rather than being integrally constructed as a one-piece unit. This configuration allows for independent manufacturing and alignment of the microlens array and fiber array, thereby improving assembly flexibility and reducing production complexity. By separating the microlens array from the fiber array, variations in optical performance can be minimized through precise positioning and calibration during assembly. In some embodiments, the microlens array may be fabricated from a material optimized for optical transmission, while the fiber array may be formed from a material selected for mechanical stability. Alternative embodiments may include the use of adhesive bonding, mechanical fastening, or thermal fusion techniques to secure the microlens array to the fiber array while maintaining positional accuracy. Such a modular design facilitates easier replacement or customization of individual components without requiring redesigning the entire optical connector assembly.

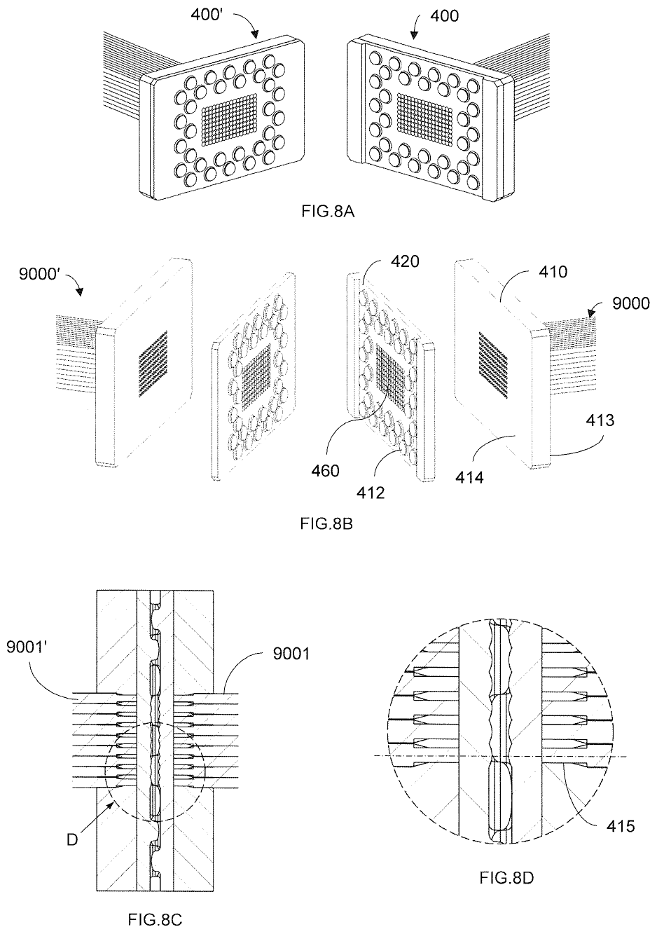

Reference now made to FIGS. 8A to 8D, a high-density optical connector 400, 400′ has a similar structure to optical connector 300, 300′ of the previous embodiment. The optical connectors 400 and 400′ have the same or similar structures; therefore, a detailed description of optical connector 400′ is omitted for clarity and brevity. Unless otherwise noted, the following description of optical connector 400 applies equally to optical connector 400′.

The optical connector 400 includes a fiber block 410 supporting the fiber group 9000 and a carrier 420 connected to the fiber block 410. The fiber block 410 includes a front surface 414, a back surface 413 and passages 415 extending from the front surface 414 through back surface 413. The passage 415 is similar to the passage 215 of the previous embodiment, therefore its description is omitted. The carrier 420 is adhered to the front surface 414 of the fiber block 410 through an adhesive such as epoxy. One of ordinary skill in the art would understand that other means can be used to connect the fiber block and the carrier, e.g., welding, bonding, etc., based on the materials of the fiber block and the carrier.

The carrier 420 is provided with a microlens array 460 at its central region and elastic averaging features 412 circumferentially disposed around the microlens array 460. The microlens array is configured to be positioned with respect to the passages 415, such that each microlens is in optical alignment with the fiber 9001 received in each passage 415. In this example, the microlens array and the elastic averaging features are internally formed with the carrier and arranged in the same configuration as in FIGS. 7A and 7B. Thus, a uniform contact is created between the optical connectors 400 and 400′ to reduce optical loss.

As in the previous embodiments, the carrier 420 may be made of glass, silicon, or a polymer that is optically transparent to the working wavelength of the intended optical signals between the optical fibers of the optical connectors 400 and 400′.

In present invention, to reduce reflectivity, anti-reflective (AR) coating may be applied to the fiber block and carrier described above. The application of AR coating further contributes to overall system reliability by reducing back-reflection that could interfere with signal integrity.

It will be understood that the embodiments described herein are provided by way of example only and are not intended to limit the scope of the present disclosure. Various modifications, substitutions, and variations may be made without departing from the spirit and scope of the invention as defined by the appended claims. All such alternatives and equivalents are considered to fall within the scope of this disclosure.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera).

1. A high-density optical connector comprising:
a fiber block including a front surface, a back surface and passages extending from the back surface towards the front surface, each passage being configured to receive an optical fiber; and
a carrier attached to the front surface of the fiber block and including a plurality of elastic averaging features spaced apart from each other,
wherein the carrier includes a plurality of first lenslets interspersed with the plurality of elastic averaging features.

2. The optical connector according to claim 1, wherein the plurality of first lenslets are distributed in a first planar array, and the plurality of the elastic averaging features are distributed in a second planar array.

3. The optical connector according to claim 1, wherein each elastic averaging feature is provided with a second lenslet, and each of the first lenslet and second lenslet is in optical alignment with an optical fiber received in each passage.

4. The optical connector according to claim 1, wherein the elastic averaging features are integrally formed with the carrier.

5. The optical connector according to claim 4, wherein the first lenslets are integrally formed with the carrier.

6. The optical connector according to claim 5, wherein the carrier is integrally formed with the fiber block as a single unitary structure.

7. The optical connector according to claim 3, wherein the passages include a first group of passages and a second group of passages, and the first lenslet is configured to align with a passage of the first group and the second lenslet is configured to align with a passage of the second group.

8. The optical connector according to claim 1, wherein the carrier includes a pair of raised pads on either pair of two opposite edges.

9. The optical connector according to claim 3, wherein the carrier is adhered to the fiber block by an adhesive.

10. The optical connector according to claim 1, wherein the fiber block is configured to support a 2-D array of optical fibers.

11. The optical connector according to claim 10, wherein the fiber block is formed from multiple layers stacked on top of each other, with each layer defining complementary grooves, such that adjacent layers cooperate to form the passage configured to securely hold an optical fiber.

12. The optical connector according to claim 3, wherein the first lenslet and second lenslet have different focal lengths.

13. The optical connector according to claim 1, wherein the elastic averaging features are configured as protrusions, and the second lenslets are located at the top of the corresponding protrusions.

14. The optical connector according to claim 1, wherein the fiber block is formed from multiple layers stacked on top of one another, each layer defining complementary grooves such that adjacent layers cooperate to form the passage.

15. An optical module comprising:
a high-density optical connector of claim 1; and
a mating carrier having a plurality of elastic averaging features configured to demountably mate with the high-density optical connector and a plurality of first lenslets alternately arranged with the elastic averaging features.

16. The optical module of claim 15, wherein each elastic averaging feature has a second lenslet.
